(19) United States
(12) Patent Application Publication
(10) Pub. No.: US 2023/0402683 A1
(43) Pub. Date: Dec. 14, 2023

(54) BATTERY SYSTEM FOR A HYBRID OR ELECTRIC VEHICLE

(71) Applicant: FORD GLOBAL TECHNOLOGIES, LLC, Dearborn, MI (US)

(72) Inventors: Bhaskara Rao Boddakayala, Troy, MI (US); Stefan Paul Pototschnik, Canton, MI (US)

(21) Appl. No.: 17/746,071

(22) Filed: May 17, 2022

(51) Int. Cl. H01M 10/6595; H01M 10/658; H01M 50/291; H01M 50/293; H01M 10/625; B60L 50/64

(52) U.S. Cl. CPC H01M 10/6595; H01M 10/658; H01M 50/291; H01M 2200/10; H01M 10/625; B60L 50/64; H01M 2220/20; H01M 50/293

(57) ABSTRACT

A battery includes a cell and a thermal barrier. The cell is configured to store and discharge electrical energy. The thermal barrier is disposed along an exterior surface of the cell. The the thermal barrier includes a thermal insulator. The thermal barrier also includes an endothermic and intumescent material. The thermal insulator engages the exterior surface of the cell. The endothermic and intumescent material is disposed on an exterior of the thermal insulator such that the thermal insulator is disposed between the cell and the endothermic and intumescent material. The endothermic and intumescent material is configured to, in response to an increase in a temperature of the cell and heat generated by the cell consuming the thermal insulator, (i) expand, (ii) engage the exterior surface of the cell, and (iii) absorb the heat generated by the cell.

### TECHNICAL FIELD

The present disclosure relates to hybrid or electric vehicles and batteries for the hybrid or electric vehicles.

### BACKGROUND

Hybrid or electric vehicles may be propelled by an electric machine that draws power from a battery.

### SUMMARY

A battery for an electric vehicle includes a plurality of cells and a plurality of thermal barriers. The plurality of cells is configured to store electrical energy and discharge the electrical energy to propel the vehicle. Each of thermal barriers is each disposed between adjacent cells of the plurality of cells. Each thermal barrier includes a first thermal insulator, a second thermal insulator, and an endothermic and intumescent layer. The first thermal insulator engages a first of the cells. The second thermal insulator engages a second of the cells. The endothermic and intumescent layer is disposed between the first and second thermal insulators. The endothermic and intumescent layer is configured to, in response to an increase in temperatures of the first and second of the cells and heat generated by the first and second of the cells consuming the first and second thermal insulators, expand, engage the first and second of the cells, and absorb the heat generated by the first and second of the cells.

A battery includes a cell and a thermal barrier. The cell is configured to store and discharge electrical energy. The thermal barrier is disposed along an exterior surface of the cell. The the thermal barrier includes a thermal insulator. The thermal barrier also includes an endothermic and intumescent material. The thermal insulator engages the exterior surface of the cell. The endothermic and intumescent material is disposed on an exterior of the thermal insulator such that the thermal insulator is disposed between the cell and the endothermic and intumescent material. The endothermic and intumescent material is configured to, in response to an increase in a temperature of the cell and heat generated by the cell consuming the thermal insulator, (i) expand, (ii) engage the exterior surface of the cell, and (iii) absorb the heat generated by the cell.

A battery includes a cell and a thermal barrier. The cell is configured to store and discharge electrical energy. The thermal barrier is disposed along an exterior surface of the cell. The thermal barrier includes a thermal insulator. The thermal barrier also includes an endothermic and intumescent material. The thermal insulator engages the exterior surface of the cell. The endothermic and intumescent material is disposed on an exterior of the thermal insulator such that the thermal insulator is disposed between the cell and the endothermic and intumescent material. The endothermic and intumescent material is configured to, in response to an increase in a temperature of the cell and heat generated by the cell not consuming the thermal insulator, (i) expand, (ii) compress and displace the thermal insulator, and (iii) absorb heat generated by the cell.

### BRIEF DESCRIPTION OF THE DRAWINGS

FIG. 1 is a schematic illustration of a representative powertrain of an electric vehicle;

FIG. 2 is a first schematic illustration of a representative battery of the powertrain;

FIG. 3 is a second schematic illustration of the representative battery;

FIG. 4 is a schematic illustration of a thermal barrier utilized in the battery; and

FIG. 5 illustrates an endothermic and intumescent layer of the thermal barrier.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

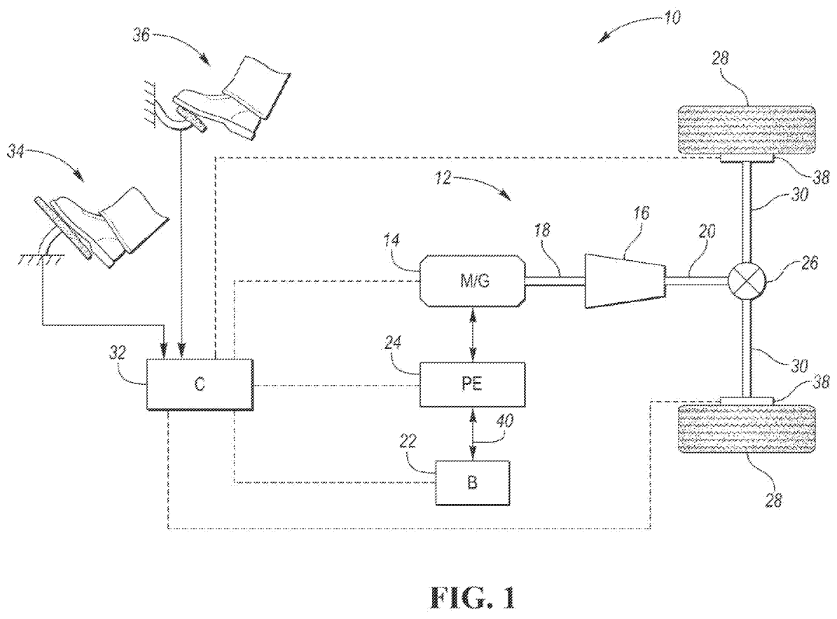

Referring to FIG. 1, a schematic diagram of an electric vehicle 10 is illustrated according to an embodiment of the present disclosure. FIG. 1 illustrates representative relationships among the components. Physical placement and orientation of the components within the vehicle may vary. The electric vehicle 10 includes a powertrain 12. The powertrain 12 includes an electric machine such as an electric motor/generator (M/G) 14 that drives a transmission (or gearbox) 16. More specifically, the M/G 14 may be rotatably connected to an input shaft 18 of the transmission 16. The transmission 16 may be placed in PRNDSL (park, reverse, neutral, drive, sport, low) via a transmission range selector (not shown). The transmission 16 may have a fixed gearing relationship that provides a single gear ratio between the input shaft 18 and an output shaft 20 of the transmission 16. A torque converter (not shown) or a launch clutch (not shown) may be disposed between the M/G 14 and the transmission 16. Alternatively, the transmission 16 may be a multiple step-ratio automatic transmission. An associated traction battery 22 is configured to deliver electrical power to or receive electrical power from the M/G 14.

The M/G 14 is a drive source for the electric vehicle 10 that is configured to propel the electric vehicle 10. The M/G 14 may be implemented by any one of a plurality of types of electric machines. For example, M/G 14 may be a permanent magnet synchronous motor. Power electronics 24 condition direct current (DC) power provided by the battery 22 to the requirements of the M/G 14, as will be described below. For example, the power electronics 24 may provide three phase alternating current (AC) to the M/G 14.

If the transmission 16 is a multiple step-ratio automatic transmission, the transmission 16 may include gear sets (not shown) that are selectively placed in different gear ratios by selective engagement of friction elements such as clutches and brakes (not shown) to establish the desired multiple discrete or step drive ratios. The friction elements are controllable through a shift schedule that connects and disconnects certain elements of the gear sets to control the ratio between the transmission output shaft 20 and the transmission input shaft 18. The transmission 16 is automatically shifted from one ratio to another based on various vehicle and ambient operating conditions by an associated controller, such as a powertrain control unit (PCU). Power and torque from the M/G 14 may be delivered to and received by transmission 16. The transmission 16 then provides powertrain output power and torque to output shaft 20.

It should be understood that the hydraulically controlled transmission 16, which may be coupled with a torque converter (not shown), is but one example of a gearbox or transmission arrangement; any multiple ratio gearbox that accepts input torque(s) from a power source (e.g., M/G 14) and then provides torque to an output shaft (e.g., output shaft 20) at the different ratios is acceptable for use with embodiments of the present disclosure. For example, the transmission 16 may be implemented by an automated mechanical (or manual) transmission (AMT) that includes one or more servo motors to translate/rotate shift forks along a shift rail to select a desired gear ratio. As generally understood by those of ordinary skill in the art, an AMT may be used in applications with higher torque requirements, for example.

As shown in the representative embodiment of FIG. 1, the output shaft 20 is connected to a differential 26. The differential 26 drives a pair of drive wheels 28 via respective axles 30 connected to the differential 26. The differential 26 transmits approximately equal torque to each wheel 28 while permitting slight speed differences such as when the vehicle turns a corner. Different types of differentials or similar devices may be used to distribute torque from the powertrain to one or more wheels. In some applications, torque distribution may vary depending on the particular operating mode or condition, for example.

The powertrain 12 further includes an associated controller 32 such as a powertrain control unit (PCU). While illustrated as one controller, the controller 32 may be part of a larger control system and may be controlled by various other controllers throughout the vehicle 10, such as a vehicle system controller (VSC). It should therefore be understood that the powertrain control unit 32 and one or more other controllers can collectively be referred to as a “controller” that controls various actuators in response to signals from various sensors to control functions such as operating the M/G 14 to provide wheel torque or charge the battery 22, select or schedule transmission shifts, etc. Controller 32 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 32 communicates with various vehicle sensors and actuators via an input/output (I/O) interface (including input and output channels) that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. As generally illustrated in the representative embodiment of FIG. 1, controller 32 may communicate signals to and/or receive signals from the M/G 14, battery 22, transmission 16, power electronics 24, and any another component of the powertrain 12 that may be included, but is not shown in FIG. 1 (i.e., a launch clutch that may be disposed between the M/G 14 and the transmission 16. Although not explicitly illustrated, those of ordinary skill in the art will recognize various functions or components that may be controlled by controller 32 within each of the subsystems identified above. Representative examples of parameters, systems, and/or components that may be directly or indirectly actuated using control logic and/or algorithms executed by the controller 32 include front-end accessory drive (FEAD) components such as an alternator, air conditioning compressor, battery charging or discharging, regenerative braking, M/G 14 operation, clutch pressures for the transmission gearbox 16 or any other clutch that is part of the powertrain 12, and the like. Sensors communicating input through the I/O interface may be used to indicate wheel speeds (WS1, WS2), vehicle speed (VSS), coolant temperature (ECT), accelerator pedal position (PPS), ignition switch position (IGN), ambient air temperature (e.g., ambient air temperature sensor 33), transmission gear, ratio, or mode, transmission oil temperature (TOT), transmission input and output speed, deceleration or shift mode (MDE), battery temperature, voltage, current, or state of charge (SOC) for example.

Control logic or functions performed by controller 32 may be represented by flow charts or similar diagrams in one or more figures. These figures provide representative control strategies and/or logic that may be implemented using one or more processing strategies such as event-driven, interrupt-driven, multi-tasking, multi-threading, and the like. As such, various steps or functions illustrated may be performed in the sequence illustrated, in parallel, or in some cases omitted. Although not always explicitly illustrated, one of ordinary skill in the art will recognize that one or more of the illustrated steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by a microprocessor-based vehicle and/or powertrain controller, such as controller 32. Of course, the control logic may be implemented in software, hardware, or a combination of software and hardware in one or more controllers depending upon the particular application. When implemented in software, the control logic may be provided in one or more computer-readable storage devices or media having stored data representing code or instructions executed by a computer to control the vehicle or its subsystems. The computer-readable storage devices or media may include one or more of a number of known physical devices which utilize electric, magnetic, and/or optical storage to keep executable instructions and associated calibration information, operating variables, and the like.

An accelerator pedal 34 is used by the driver of the vehicle to provide a demanded torque, power, or drive command to the powertrain 12 (or more specifically M/G 14) to propel the vehicle. In general, depressing and releasing the accelerator pedal 34 generates an accelerator pedal position signal that may be interpreted by the controller 32 as a demand for increased power or decreased power, respectively. A brake pedal 36 is also used by the driver of the vehicle to provide a demanded braking torque to slow the vehicle. In general, depressing and releasing the brake pedal 36 generates a brake pedal position signal that may be interpreted by the controller 32 as a demand to decrease the vehicle speed. Based upon inputs from the accelerator pedal 34 and brake pedal 36, the controller 32 commands the torque and/or power to the M/G 14, and friction brakes 38. The controller 32 also controls the timing of gear shifts within the transmission 16.

The M/G 14 may act as a motor and provide a driving force for the powertrain 12. To drive the vehicle with the M/G 14 the traction battery 22 transmits stored electrical energy through wiring 40 to the power electronics 24 that may include inverter and rectifier circuitry, for example. The inverter circuitry of the power electronics 24 may convert DC voltage from the battery 22 into AC voltage to be used by the M/G 14. The rectifier circuitry of the power electronics 24 may convert AC voltage from the M/G 14 into DC voltage to be stored with the battery 22. The controller 32 commands the power electronics 24 to convert voltage from the battery 22 to an AC voltage provided to the M/G 14 to provide positive or negative torque to the input shaft 18.

The M/G 14 may also act as a generator and convert kinetic energy from the powertrain 12 into electric energy to be stored in the battery 22. More specifically, the M/G 14 may act as a generator during times of regenerative braking in which torque and rotational (or kinetic) energy from the spinning wheels 28 is transferred back through the transmission 16 and is converted into electrical energy for storage in the battery 22.

It should be understood that the vehicle configuration described herein is merely exemplary and is not intended to be limited. Other electric or hybrid electric vehicle configurations should be construed as disclosed herein. Other electric or hybrid vehicle configurations may include, but are not limited to, series hybrid vehicles, parallel hybrid vehicles, series-parallel hybrid vehicles, plug-in hybrid electric vehicles (PHEVs), fuel cell hybrid vehicles, battery operated electric vehicles (BEVs), or any other vehicle configuration known to a person of ordinary skill in the art.

In hybrid configurations that include an internal combustion engine such as a gasoline, diesel, or natural gas powered engine, or a fuel cell, the controller 32 may be configured to control various parameters of such an internal combustion engine. Representative examples of internal combustion parameters, systems, and/or components that may be directly or indirectly actuated using control logic and/or algorithms executed by the controller 32 include fuel injection timing, rate, and duration, throttle valve position, spark plug ignition timing (for spark-ignition engines), intake/exhaust valve timing and duration, etc. Sensors communicating input through the I/O interface from such an internal combustion engine to the controller 32 may be used to indicate turbocharger boost pressure, crankshaft position (PIP), engine rotational speed (RPM), intake manifold pressure (MAP), throttle valve position (TP), exhaust gas oxygen (EGO) or other exhaust gas component concentration or presence, intake air flow (MAF), etc.

It should be understood that the schematic illustrated in FIG. 1 is merely representative and is not intended to be limiting. Other configurations are contemplated without deviating from the scope of the disclosure. For example, the vehicle powertrain 12 may be configured to deliver power and torque to the one or both of the front wheels as opposed to the illustrated rear wheels 28.

As the range of electric vehicles increases, more battery cells may be connected in parallel in battery packs. If one or more cells are experiencing thermal runaway, where the temperature of the cell is significantly increasing to levels higher than operable temperatures, electrical energy may transfer from the other cells to a cell that is experiencing the thermal runaway, resulting in further temperature increases in the cell experiencing the thermal runaway. Some of the heat from the cell that is experiencing thermal runaway may then be transferred to the other cells through the parallel connections. In order to slow down such thermal propagation between the battery cells, insulating materials may be disposed between cells. The configuration disclosed herein, includes a thermal barrier that significantly slows down thermal propagation between the battery cells, which is particularly advantageous if when one or more of the cells are experiencing thermal runaway.

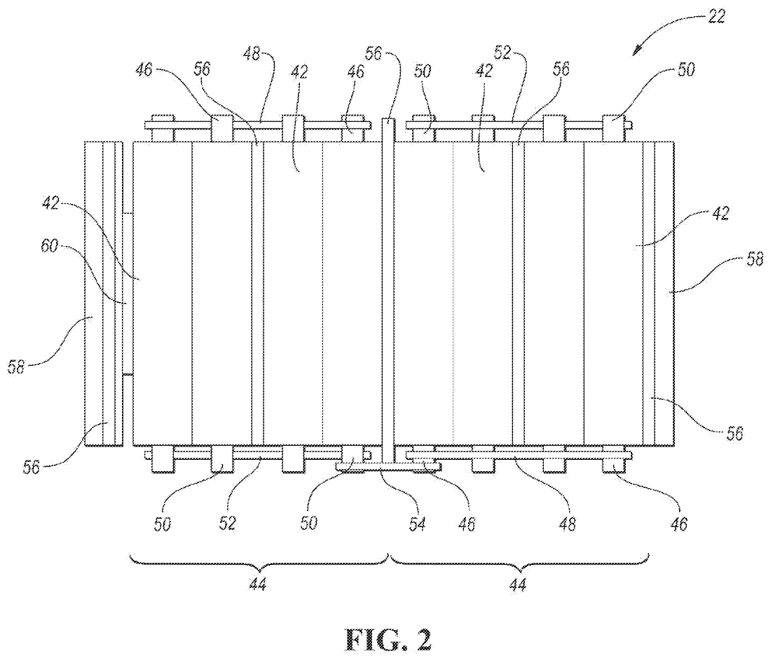

Referring to FIG. 2, a first schematic illustration of the battery 22 is illustrated. The battery 22 includes a plurality of cells 42 that are configured to store electrical energy and to discharge the electrical energy to the M/G 14 to propel the vehicle 10. The cells 42 may be arranged in cell banks 44 having subsets of cells 42. The subsets of cells 42 within each cell bank 44 may be arranged or electrically connected to each other in parallel. More specifically, positive terminals 46 within each cell bank 44 are connected to each other via electrical connections 48 and negative terminals 50 within each cell bank 44 are connected to each other via electrical connections 52 such that the cells 42 within each cell bank 44 are electrically connected in parallel. The cell banks 44 may be arranged or electrically connected to each other in series. More specifically, adjacent cell banks 44 may be connected to each other via electrical connections 54 that connect a positive terminal 46 of one cell bank 44 to a negative terminal 50 another cell bank 44.

Thermal barriers 56 may be disposed between adjacent cell banks 44. The thermal barriers may also be disposed between subsets of cells 42 within a single cell bank 44. The battery may also include end plates 58. Thermal barriers 56 may also be disposed between the end plates 58 and an adjacent cell 42. The thermal barriers 56 may be comprised of an insulating material that is configured to restrict heat transfer, an endothermic material that is configured to absorb heat, or a combination of such materials. The properties and composition of the thermal barriers 56 may vary within the battery 22. For example, some of the thermal barriers 56 may only include an insulating material, some thermal barriers 56 may only include an endothermic material, and some thermal barriers 56 may include both insulating and endothermic materials. The battery 22 may also include a heating pad 60 that is configured to warm the battery 22 when the temperature is below optimum operating temperatures.

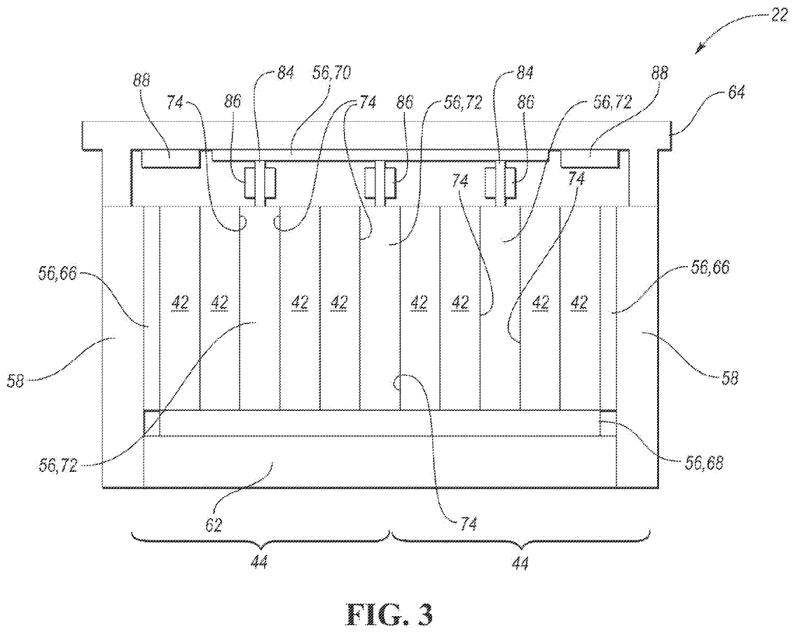

Referring to FIG. 3, a second schematic illustration of the battery 22 is illustrated. The second illustration further includes a bottom plate 62 to support the cells 42, a cover 64 for the cells 42, and additional thermal barriers 56. A first of the additional thermal barriers 56 is disposed between the bottom plate 62 and the cells 42 while a second of the additional thermal barriers 56 is disposed between the cover 64 and the cells 42. The positive terminals 46, electrical connections 48, negative terminals 50, electrical connections 52, electrical connection 54, and heating pad 60 are not shown in FIG. 3 for illustrative purposes.

The thermal barriers 56 disposed between end plates 58 and one of the cells 42 may be referred to as outer thermal barriers 66. The outer thermal barriers 66 may be made from an insulating material that operates to reduce heat transfer between the battery 22 and the exterior of the battery 22, such as an insulating foam (e.g., polyurethane foam). The thermal barrier 56 that is disposed between the bottom plate 62 and the cells 42 may be referred to as the bottom thermal barrier 68. The bottom thermal barrier 68 may also be made from an insulating material that operates to reduce heat transfer between the battery 22 and the exterior of the battery 22, such as an insulating foam (e.g., polyurethane foam). The thermal barrier 56 that is disposed between the cover 64 and the cells 42 may be referred to as the top thermal barrier 70. The top thermal barrier 70 may be made from a material having endothermic and intumescent properties (e.g., an endothermic and intumescent aerogel), which is configured to absorb heat and expand as the heat is absorbed. The thermal barriers 56 disposed between adjacent cells 42 or between adjacent cell banks 44 may be referred to as intermediate thermal barriers 72. The intermediate thermal barriers 72 may be made from a combination of insulating materials (e.g., polyurethane foam) and materials having endothermic and intumescent properties (e.g., an endothermic and intumescent aerogel).

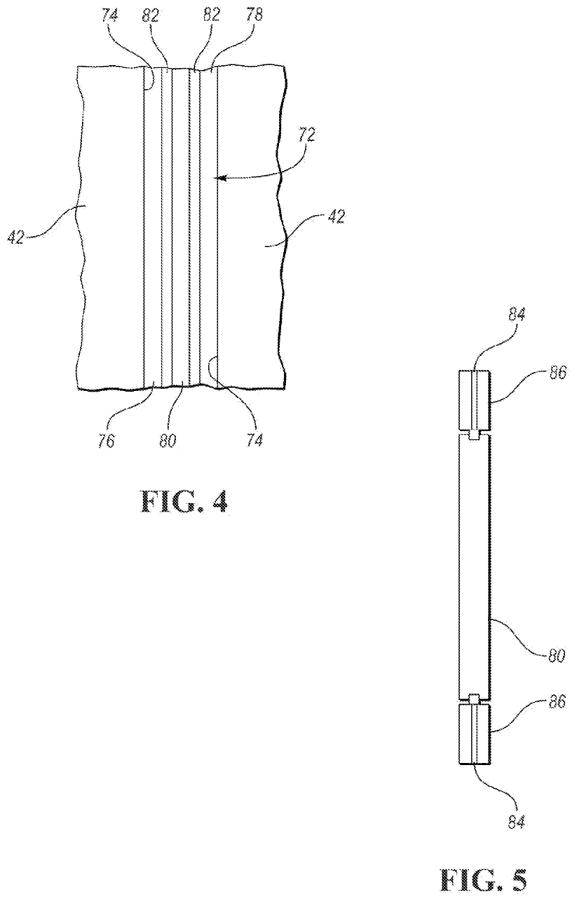

Referring to FIGS. 3-5, the intermediate thermal barriers 72 are illustrated in further detail. The intermediate thermal barriers 72 are disposed along exterior surfaces 74 of adjacent cells 42. Each of the intermediate thermal barriers 72 includes a first thermal insulator 76 engaging a first of the cells 42, a second thermal insulator 78 engaging a second of the cells 42, and an endothermic and intumescent material or layer 80 disposed between the first thermal insulator 76 and the second thermal insulator 78. A doubled sided tape material 82 having adhesive properties, or another adhesive, may secure the endothermic and intumescent layer 80 to the first thermal insulator 76 and to the second thermal insulator 78. The first thermal insulator 76 and the second thermal insulator 78 may be made from an insulating material that operates to reduce heat transfer, such as an insulating foam (e.g., polyurethane foam). The endothermic and intumescent layer 80 may be made from a material having endothermic and intumescent properties (e.g., an endothermic and intumescent aerogel). The outer thermal barriers 66 may have the same configuration as the intermediate thermal barriers 72 (i.e., an endothermic and intumescent layer 80 sandwiched between two thermal insulators via a doubled sided tape or other adhesive) as opposed to only being a thermal insulator. Alternatively, refractory ceramic fibers may be utilized in layer 80. The refractory ceramic fibers have high a temperature capability, high chemical resistance, high thermal shock resistance, low heat loss, and low thermal conductivity.

The first thermal insulator 76 and the second thermal insulator 78 of each intermediate thermal barrier 72 may more specifically be disposed on and engage the exterior surfaces 74 of the adjacent cells 42. The endothermic and intumescent layer 80 may be exterior the first thermal insulator 76 relative the cell 42 that is adjacent and secured to the first thermal insulator 76 such that the first thermal insulator 76 is disposed between the said adjacent cell 42 and the endothermic and intumescent layer 80. The endothermic and intumescent layer 80 may also be exterior the second thermal insulator 78 relative the cell 42 that is adjacent and secured to the second thermal insulator 78 such that the second thermal insulator 78 is disposed between the said adjacent cell 42 and the endothermic and intumescent layer 80.

The endothermic and intumescent layer 80 is configured to, in response to an increase in temperatures of the adjacent cells 42 and heat generated by adjacent cells 42 consuming the first thermal insulator 76 and the second thermal insulator 78, (i) expand, (ii) engage the adjacent cells 42 (e.g., contact the exterior surfaces 74 of adjacent cells 42), and (iii) absorb the heat generated by the adjacent cells 42. The endothermic and intumescent layer 80 is also configured to, in response to the increase in the temperatures of the adjacent cells 42 and the heat generated by the adjacent cells 42 not consuming the first thermal insulator 76 and the second thermal insulator 78, (i) expand, (ii) compress and displace first thermal insulator 76 and the second thermal insulator 78, and (iii) absorb the heat generated by the adjacent cells 42. It is noted that the endothermic and intumescent layer 80 may alternatively only expand into one of the first thermal insulator 76 or the second thermal insulator 78 if heat is only being transferred from one direction or if the endothermic and intumescent layer 80 is only secured to a single thermal insulator that is sandwiched between the endothermic and intumescent layer 80 and one of the cells 42.

During thermal runaway of one or more cells 42, the first thermal insulator 76 and the second thermal insulator 78 may be consumed at a temperature that is above a threshold value. The endothermic and intumescent layer 80 will then absorb heat and uniformly expand to occupy empty space created due to consumption of the first thermal insulator 76 and the second thermal insulator 78. The expansion and heat absorption of the endothermic and intumescent layer 80 will further reduce temperatures of neighboring or adjacent cells 42.

If the first thermal insulator 76 and the second thermal insulator 78 are polyurethane foam and if the endothermic and intumescent layer 80 is an endothermic and intumescent aerogel, the first thermal insulator 76 and the second thermal insulator 78 will be consumed at a temperature of approximately 135° C. The aerogel operates to further insulate the cells 42 at higher temperatures after the first thermal insulator 76 and the second thermal insulator 78 have been consumed due to the higher insulation capability of aerogel system (0.03 w/mk at 300° C.). Such an endothermic and intumescent aerogel is able to withstand temperatures of up to 1200° C. and has high heat absorption and high thermal resistance due to a low thermal conductivity at higher temperatures.

The first thermal insulator 76 and the second thermal insulator 78 may be elastic so that the expanding endothermic and intumescent layer 80 may compress the first thermal insulator 76 and the second thermal insulator 78. More specifically, the first thermal insulator 76 and the second thermal insulator 78 may have a Shore A durometer that ranges between thirty and forty.

Each intermediate thermal barrier 72 may also include protrusions or tabs 84 that extend outward from the intermediate thermal barriers 72. More specifically, the tabs 84 may extend upward and downward from top and bottom surfaces of the endothermic and intumescent layer 80. The tabs 84 may be part of seal that that retains the material of the endothermic and intumescent layer 80. The tabs 84 may also be coated with an endothermic and intumescent material 86, such as an endothermic and intumescent aerogel, which is also configured to expand and absorb heat generated by the cells 42.

The intumescent endothermic coating material 86 may activate when the battery cells 42 go into thermal runaway and the surrounding temperature exceeds a threshold. The intumescent endothermic coating material 86 may expand into the areas where there is no active cell material, hence will not affect operation neighboring battery cells. The intumescent endothermic coating material 86 also absorbs heat energy during thermal runaway events of one more of the cells 44 and may function to reduce or eliminate heat transfer between cells 42 via convection of hot gasses within voids defined with the battery 22.

Microcapsule sheets 88 may be disposed over one or more of the cells 42. Each microcapsule sheet 88 may be disposed over one cell 42 or subsets that include multiple cells 42. The microcapsule sheets 88 may be disposed over a portion of the cells 42, as illustrated in FIG. 3. Alternatively, the microcapsule sheets 88 may be disposed over all of the cells 42. For Example, the microcapsule sheets 88 may be positioned over the middle section of cells 42 in lieu of the top thermal barrier 70. The microcapsule sheets 88 are illustrated as being secured to the cover 64 and spaced apart from the cells 44. In an alternative embodiment, the microcapsule sheets 88 may be positioned directly on exterior surfaces (e.g., top surfaces) of the cells 42. The microcapsule sheets 88 include small capsules (e.g., microcapsules) or containers that contain a dielectric coolant or cooling fluid. In response to an increase in temperature of the microcapsule sheets 88 that exceeds a threshold, the microcapsule sheets 88 are configured to release the dielectric coolant onto the cells 42 in order to further cools the cells 42. More specifically, the capsules or containers within the microcapsule sheets 88 may expand and rupture to release the dielectric coolant or may contain nozzles that are sized to retain the dielectric coolant below the threshold temperature and release the dielectric coolant above the threshold temperature, which results from the decrease in viscosity of the dielectric coolant as the temperature of the dielectric coolant increases. Releasing the dielectric fluid acts as cooling agent to reduce the temperature of the cells 42, particularly during a thermal runaway event. Releasing the dielectric fluid may also reduce a vent gas temperature (e.g., the temperature of gases within void of the battery 22) during a thermal runaway event.

The illustration of the battery 22 in FIGS. 2 and 3 includes two cell banks 44 each having four cells 42 with a thermal barrier 56 between each cell bank 44 and between the middle two cells 42 within each cell bank. It should be understood that FIGS. 2 and 3 are not meant to be limiting and that the battery 22 may include any number of cell banks 44, each cell bank 44 may include any number of cells 42, and the thermal barriers 56 may be disposed between any of the cells 42 or between an end plate and an adjacent cell 42.

An advantage of utilizing the structure of the intermediate thermal barriers 72 between parallel cells 42 is that the intermediate thermal barriers 72 prolongs the time for electrical energy from the parallel cells 42 to transfer to a cell 42 that is experiencing thermal runaway. As a result, it takes longer for the next cell in the parallel configuration to go into thermal runaway. Furthermore, if the next cell 42 in the parallel configuration does go into thermal runaway, it will be at lower state of charge and therefore will have less stored energy to increase the temperature of the cell 42 during the thermal runaway event. Placing the intermediate thermal barriers 72 in the middle of a cell bank 44 also prolongs the time for heat to transfer through the thermally conductive connections, which results in a longer propagation time to transfer heat, or may even arrest thermal propagation between cells 42.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

1. A battery for an electric vehicle comprising:
a plurality of cells configured to store electrical energy and discharge the electrical energy to propel the vehicle; and
a plurality of thermal barriers each disposed between adjacent cells of the plurality of cells, wherein each thermal barrier includes,
a first thermal insulator engaging a first of the cells,
a second thermal insulator engaging a second of the cells, and
an endothermic and intumescent layer disposed between the first and second thermal insulators, wherein a thermal resistance of the endothermic and intumescent layer is greater than a thermal resistance of the first and second thermal insulation layers such that the endothermic and intumescent layer is configured to, in response to an increase in temperatures of the first and second of the cells and heat generated by the first and second of the cells consuming the first and second thermal insulators, (i) expand, (ii) engage the first and second of the cells, and (iii) absorb the heat generated by the first and second of the cells.

2. The battery of claim 1, wherein the endothermic and intumescent layer is configured to, in response to the increase in the temperatures of the first and second of the cells and the heat generated by the first and second of the cells not consuming the first and second thermal insulators, (i) expand, (ii) compress and displace the first and second thermal insulators, and (iii) absorb the heat generated by the first and second of the cells.

3. The battery of claim 2, wherein the first and second thermal insulators have a Shore A durometer reading that ranges between thirty and forty.

4. The battery of claim 1, wherein (i) the plurality of cells includes cell banks having subsets of cells, (ii) the subsets of cells within each cell bank are arranged in parallel, and (iii) the cell banks are arranged in series.

5. The battery of claim 4, wherein the thermal barriers are disposed between adjacent cell banks.

6. The battery of claim 4, wherein the thermal barriers are disposed between adjacent subsets of cells within each cell bank.

7. The battery of claim 1 further comprising a microcapsule sheet disposed over the plurality of cells, wherein the microcapsule sheet is configured to release a dielectric coolant onto the plurality of cells in response to a temperature of the microcapsule sheet exceeding a threshold.

8. The battery of claim 1, wherein the plurality of thermal barriers includes tabs extending outward, and wherein the tabs are coated with an endothermic and intumescent material.

9. A battery comprising:
a cell configured to store and discharge electrical energy; and
a thermal barrier disposed along an exterior surface of the cell, wherein the thermal barrier includes,
a thermal insulator engaging the exterior surface of the cell, and
an endothermic and intumescent material disposed on an exterior of the thermal insulator such that the thermal insulator is disposed between the cell and the endothermic and intumescent material, wherein the endothermic and intumescent material is configured to, in response to an increase in a temperature of the cell and heat generated by the cell consuming the thermal insulator, (i) expand, (ii) engage the exterior surface of the cell, and (iii) absorb the heat generated by the cell.

10. The battery of claim 9, wherein the endothermic and intumescent material is configured to, in response to the increase in the temperature of the cell and the heat generated by the cell not consuming the thermal insulator, (i) expand, (ii) compress and displace the thermal insulator, and (iii) absorb the heat generated by the cell.

11. The battery of claim 10, wherein the thermal insulator has a Shore A durometer reading that ranges between thirty and forty.

12. The battery of claim 9 further comprising a microcapsule sheet disposed over the cell, wherein the microcapsule sheet is configured to release a dielectric coolant onto the cell in response to a temperature of the microcapsule sheet exceeding a threshold.

13. The battery of claim 9, wherein the thermal barrier includes an outward extending tab, and wherein the tab is coated with the endothermic and intumescent material.

14. The battery of claim 9, wherein the thermal insulator is a polyurethane foam, and wherein the endothermic and intumescent material is an aerogel.

15. A battery comprising:
a cell configured to store and discharge electrical energy; and
a thermal barrier disposed along an exterior surface of the cell, wherein the thermal barrier includes,
a thermal insulator engaging the exterior surface of the cell, and
an endothermic and intumescent material disposed on an exterior of the thermal insulator such that the thermal insulator is disposed between the cell and the endothermic and intumescent material, wherein the endothermic and intumescent material is configured to, in response to an increase in a temperature of the cell and heat generated by the cell not consuming the thermal insulator, (i) expand, (ii) compress and displace the thermal insulator, and (iii) absorb heat generated by the cell.

16. The battery of claim 15, wherein the endothermic and intumescent material is configured to, in response to the increase in temperature of the cell and the heat generated by the cell consuming the thermal insulator, (i) expand, (ii) engage the cell, and (iii) absorb the heat generated by the cell.

17. (canceled)

18. The battery of claim 15 further comprising a microcapsule sheet disposed over the cell, wherein the microcapsule sheet is configured to release a dielectric coolant onto the cell in response to a temperature of the microcapsule sheet exceeding a threshold.

19. The battery of claim 15, wherein the thermal barrier includes an outward extending tab, and wherein the tab is coated with the endothermic and intumescent material.

20. (canceled)

21. The battery of claim 9, wherein a thermal resistance of the endothermic and intumescent layer is greater than a thermal resistance of the first and second thermal insulation layers.

22. The battery of claim 15, wherein a thermal resistance of the endothermic and intumescent layer is greater than a thermal resistance of the first and second thermal insulation layers.
